(19) United States
(12) Patent Application Publication
(10) Pub. No.: US 2008/0256822 A1
(43) Pub. Date: Oct. 23, 2008

(54) Container for freeze-drying

(76) Inventors: Hiroko Suzuki, Yokohama (JP); Massashi Kanda, Utsunomiya-si (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/788,353

(22) Filed: Apr. 19, 2007

(51) Int. Cl. A23L 3/44

(52) U.S. Cl. 34/92

(57) ABSTRACT

A container is provided that realizes efficient freeze-drying while preventing contamination during freeze-drying. This freeze-drying container uses a nonporous moisture-permeable film in at least a portion thereof, and the nonporous moisture-permeable film can be formed from a polyurethane or a polyester elastomer.

### BACKGROUND OF THE INVENTION

1. Field of the Invention

The present invention relates to a container for freeze-drying in which is placed articles such as foods and medicines to be freeze-dried.

2. Description of the Related Art

Freeze-drying of foods and medicines is carried out widely for the purpose of extending the expiration date and facilitating handling. Freeze-drying is carried out by placing a food or medicine in a freeze-drying apparatus and volatilizing the moisture in the article in a vacuum.

An example of a technology for preventing contamination is disclosed in JP2001-106242A. JP2001-106242A discloses a container for freeze-drying. It consists of a polymer container with an air vent port which can take an open position and a sealed position. The advantage of this invention is said to be low contamination in the freeze-dried product. However, if an air vent port is formed as in JP2001-106242A, contamination ends up occurring to a certain extent during freeze-drying through this air vent port. In addition, since there is a single moisture outlet, unevenness tends to occur in the degree of volatilization of moisture in the freeze-dried article.

In addition, U.S. Pat. No. 5,309,649 (Japanese Patent Application Laid-open No. H2-29256, Japanese Patent Publication No. H4-50830) discloses a technology for preventing contamination by forming a portion of a container with a hydrophobic, porous, microorganism-impermeable, water vapor-permeable membrane (see patent document 2). However, in the case a port is open, moisture tends to enter through that port particularly following freeze-drying. In addition, contamination by molecules having a smaller size than the diameter of the port cannot be prevented in principle.

### SUMMARY OF THE INVENTION

An object of the present invention is to provide a container that prevents contamination during freeze-drying and realizes efficient freeze-drying.

The present invention relates to a container sealing and housing a freeze-dried article, wherein at least a part of the container is made of a nonporous moisture-permeable film. Here, the nonporous moisture-permeable film may comprises a hydrophilic polymer selected from the group consisting of copolyether urethane, a mixture of two or more types of copolyether urethanes, copolyether ester elastomer, a mixture of two or more types of copolyether ester elastomers, polyether block polyamide, a mixture of two or more types of polyether block polyamides, a homopolymer or copolymer of polyvinyl alcohol and two or more types of homopolymers or copolymers of polyvinyl alcohol, or may be a composite with the above-mentioned hydrophilic polymers and a support.

The container for freeze-drying of the present invention may adapt, but not limited to, one of the following embodiments.

(1) a nonporous moisture-permeable film that composes the entirety thereof

(2) a tray in which an article to be freeze-dried is placed, and a nonporous moisture-permeable film affixed to an opening of the tray

(3) a container in which an article to be freeze-dried is placed, and a cover removably attached to the container in which a nonporous moisture-permeable film is arranged in a portion thereof

(4) a container body in which an article to be freeze-dried is placed, a nonporous moisture-permeable film that covers an opening of the container body, and a tightening member that presses the nonporous, moisture-permeable film against the container body.

Contamination during freeze-drying is prevented. More specifically, contamination is prevented when an article to be freeze-dried is placed in and removed from a freeze-drying apparatus. In addition, contamination of components in the freeze-drying apparatus is prevented during freeze-drying. Water easily permeates the nonporous, moisture-permeable film due to its small molecular size. On the other hand, the majority of the flavor components and so on have difficulty in permeating the nonporous, moisture-permeable film. As a result, articles can be freeze-dried without allowing flavor components to escape. Since contamination is prevented, two or more different types of foods can be freeze-dried simultaneously.

### BRIEF DESCRIPTION OF THE DRAWINGS

FIG. 1 indicates drawings showing one aspect of a container for freeze-drying of the present invention, with FIG. 1A being a perspective view showing a state before housing an article to be freeze-dried, and FIG. 1B being an elevation showing a state before housing an article to be freeze-dried;

FIG. 2 indicates drawings showing another aspect of the container for freeze-drying of the present invention, with FIG. 2A being a perspective view and FIG. 2B being a cross-sectional elevation;

FIG. 3 indicates drawings showing still another aspect of the container for freeze-drying of the present invention, with FIG. 3A being a perspective view and FIG. 3B being a cross-sectional elevatin; and

FIG. 4 indicates drawings showing still another aspect of the container for freeze-drying of the present invention, with FIG. 4A being a perspective view and FIG. 4B being a cross-sectional elevation.

### DESCRIPTION OF THE PREFERRED EMBODIMENTS

The container for freeze-drying of the present invention is a container for sealing and housing an article to be freeze-dried using a nonporous, moisture-permeable film in at least a portion thereof.

The nonporous, waterproof, windproof moisture-permeable film used in the invention must be hydrophilic. Because of the film's hydrophilic properties, moisture adhering to the surface of such a film can permeate to and diffuse through the interior of the film, making it possible to release water vapor from the back face of the film where the water vapor concentration is low. Various hydrophilic polymers can be used as the film having such properties.

As used herein, the term “hydrophilic polymers” means polymers which absorb water when in contact with liquid water moisture at room temperature according to the International Standards Organization specification ISO 62 (equivalent to the American Society for Testing and Materials specification ASTM D 570).

The hydrophilic polymer suitable for preparing the hydrophilic, nonporous membranes for use in the present invention can be one or a blend of several polymers, for example, the hydrophilic polymer can be a copolyether ester elastomer or a mixture of two or more copolyether ester elastomers as described below, such as polymers available from E. I. du Pont de Nemours and Company under the trade name Hytrel® or a polyether block polyamide, or a mixture of two or more polyether block polyamides, such as polymers available from the Elf-Altochem Company of Paris, France under the trade name of PEBAX; or a polyether urethane or a mixture of two or more polyether urethanes; or homopolymers or copolymers of polyvinyl alcohol or a mixture of homopolymers or copolymers of polyvinyl alcohol.

A particularly preferred polymer for water vapor transmission in this invention is a copolyether ester elastomer or mixture of two or more copolyether ester elastomers having a multiplicity of recurring long-chain ester units and short-chain ester units joined head-to-tail through ester linkages, where the long-chain ester units are represented by the formula:

—O-G-OCO—R—CO— (I)

and said short-chain ester units are represented by the formula:

—O-D-OCO—R—CO— (II)

wherein:

a) G is a divalent radical remaining after the removal of terminal hydroxyl groups from a poly(alkylene oxide)glycol having a number average molecular weight of about 400 to 4000;

b) R is a divalent radical remaining after removal of carboxyl groups from a dicarboxylic acid having a molecular weight of less than 300;

c) D is a divalent radical remaining after removal of hydroxyl groups from a diol having a molecular weight of less than about 250; optionally

d) the copolyether ester contains 0 to 68 weight percent, based on the total weight of the copolyether ester, ethylene oxide groups incorporated in the long-chain ester units of the copolyether ester; and

e) the copolyether ester contains about 25 to 80 weight percent short-chain ester units.

This preferred polymer is suitable for fabricating into thin but strong membranes, films and coatings. The preferred polymer, copolyether ester elastomer and methods of making it are known in the art, such as are disclosed in U.S. Pat. No. 4,725,481 for a copolyether ester elastomer with a WVTR of at least 3500 g/m²/24 hr, or U.S. Pat. No. 4,769,273 for a copolyether ester elastomer with a WVTR of 400 to 2500 g/m²/24 hr. Both are incorporated herein by reference in their entirety.

In the present invention, a “nonporous” film refers to the absence of penetrating pores in both sides of the film, and more specifically, refers to the absence of pores when observed with an electron microscope at a magnification factor of 10,000.

The polymer can be compounded with antioxidant, ultraviolet stabilizers, hydrolysis stabilizers, dyes or pigments, fillers, antimicrobial reagents and the like.

The use of commercially available hydrophilic polymers as membranes is possible in the context of the present invention, although it is more preferable to use copolyether ester elastomers having a WVTR or more than 400 g/m²/24 hr measured on a film of a thickness of 25 microns using air at 23° C. and 50% relative humidity at a velocity of 3 m/s. Most preferred is the use of membranes made from commercially available copolyether ester elastomers having a WVTR of more than 3500 g/m²/24 hr, measured on a film of a thickness of 25 microns using air at 23° C. and 50% relative humidity at a velocity of 3 m/s.

The hydrophilic polymers can be manufactured into membranes of any desired thickness by a number of processes. A useful and well-established way to make membranes in the form of films is by melt extrusion of the polymer on a commercial extrusion line. Briefly, this entails heating the polymer to a temperature above the melting point, extruding it through a flat or annular die and then casting a film using a roller system or blowing a film from the melt.

The nonporous, moisture-permeable film of the present invention may also be a composite of the above-mentioned hydrophilic polymer and a support. For example, the nonporous, moisture-permeable film may be a composite having a film of the hydrophilic polymer on a support. A mesh formed with a non-woven fabric, woven fabric, knit, paper or other material (such as metal, plastic or fibers) can be used for the support. A support is useful in that it imparts mechanical strength to the nonporous, moisture-permeable film, and is able to prevent rupturing of the container in the case expansion of the container has occurred due to the release of water vapor from the article to be freeze-dried.

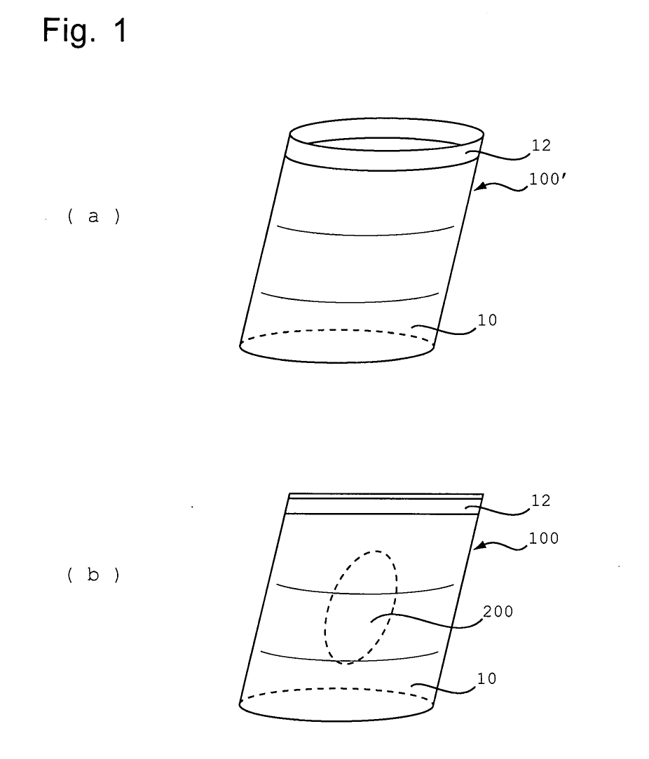

The container for freeze-drying of the present invention is characterized by sealing and housing an article to be freeze-dried using the above-mentioned nonporous, moisture-permeable film in at least a portion thereof. As shown in FIG. 1, one aspect of the container for freeze-drying of the present invention may be a pouch composed entirely of the nonporous, moisture-permeable film, or a pouch in which a portion thereof is composed of the nonporous, moisture-permeable film. FIG. 1A is a drawing showing a container for freeze-drying 100′ in the state before housing an article to be freeze-dried. This container for freeze-drying 100′ has a sample entry port 12, and the entirety is formed with a nonporous, moisture-permeable film 10. After housing an article to be freeze-dried 200 before or after preliminary freeze-drying in the container 100 by inserting through the sample entry port 12, the sample entry port 12 is sealed allowing the obtaining of a sealed container for freeze-drying 100 as shown in FIG. 1B. Sealing of the sample entry port 12 can be carried out by heat sealing or ultrasonically sealing the nonporous, moisture-permeable film, or mechanically sealing the film with a sealing member and the like.

The pouch-like container for freeze-drying 100′ shown in FIG. 1A can be formed by, for example, (a) folding a single nonporous, moisture-permeable film in half and joining all portions thereof except for the portion serving as the sample entry port, (b) superimposing two nonporous, moisture-permeable films and joining all portions thereof except of the portion serving as the sample entry port, or (c) superimposing a nonporous, moisture-permeable film and a non-moisture-permeable film, and joining all portions thereof except for the portion serving as the sample entry port. Joining of the nonporous, moisture-permeable films or the nonporous, moisture-permeable film and a non-moisture-permeable film can be carried out by using any suitable method known in the art, such as heat sealing or ultrasonic sealing. As previously described, the nonporous, moisture-permeable film 10 may be a hydrophilic polymer film or a composite of a hydrophilic polymer and a support. Here, in the case the nonporous, moisture-permeable film is formed with a composite of a hydrophilic polymer and a support, the hydrophilic polymer is preferably positioned on the inside of the container. As a result of adopting such an orientation, in addition to it being possible to join the films using the same methods described above, the effect of the support of improving mechanical strength can be demonstrated effectively.

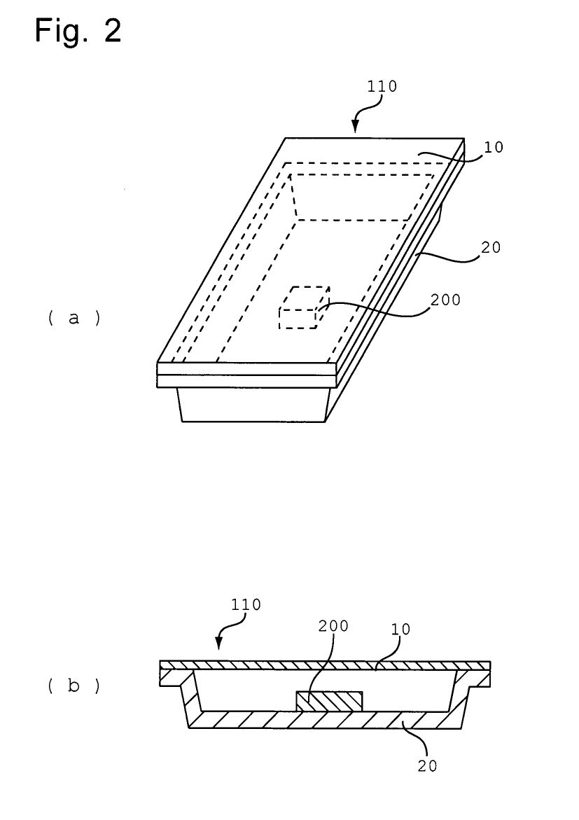

Another aspect of the container for freeze-drying of the present invention is shown in FIG. 2. FIG. 2A is a perspective view of a container for freeze-drying 110, while FIG. 2B is a cross-sectional elevation of the same. The container for freeze-drying 110 is composed of a tray 20 for housing an article to be freeze-dried 200, and a nonporous, moisture-permeable film 10 affixed to an opening of the tray 20. The tray 20 is formed using a material impermeable to moisture and contaminants known the art (such as metal or plastic). The tray 20 is preferably formed using a material capable of affixing and adhering the nonporous, moisture-permeable film 10 without using an adhesive. As was previously described, the nonporous, moisture-permeable film 10 may be a hydrophilic polymer film or a composite of a hydrophilic polymer and a support. In the case of using a nonporous, moisture-permeable film formed with a composite of a hydrophilic polymer and a support, the hydrophilic polymer is preferably positioned on the side of the tray 20. As a result of employing such as orientation, not only can the nonporous, moisture-permeable film 10 be affixed and adhered to the tray 20 by the hydrophilic polymer, but the effect of the support of improving mechanical strength can be effectively demonstrated.

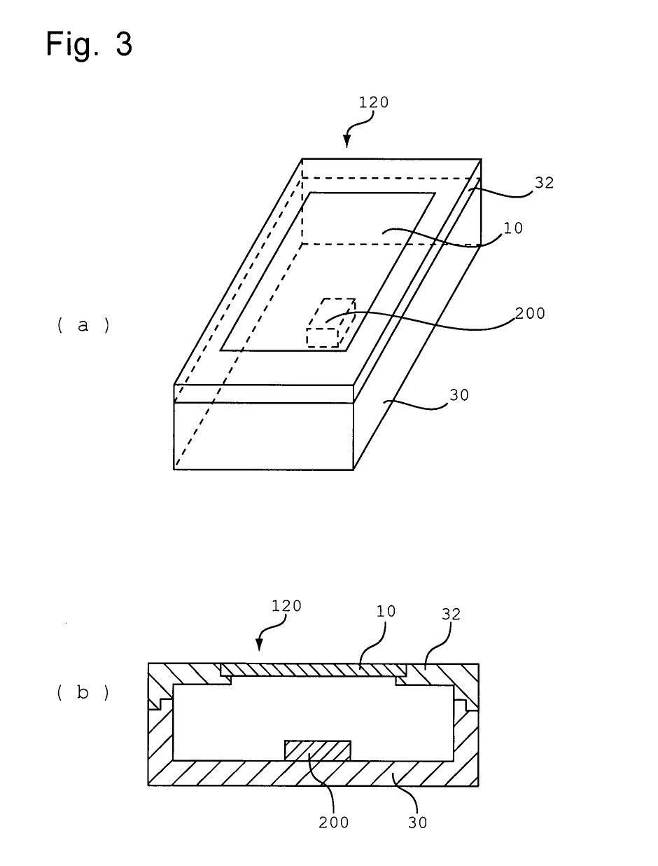

Still another aspect of the container for freeze-drying of the present invention is shown in FIG. 3. FIG. 3A is a perspective view of a container for freeze-drying 120, while FIG. 3B is a cross-sectional elevation of the same. The container for freeze-drying 120 is composed of a container body 30 for housing an article to be freeze-dried 200, and a cover 32 removably attached to the container body 30, and a nonporous, moisture-permeable film 10 is attached to a portion of the cover 32. The cover 32 of the container body 30 is formed using a material impermeable to moisture and contaminants known in the art (such as metal or plastic). The cover 32 is preferably formed using a material capable of affixing and adhering the nonporous, moisture-permeable film 10 without using an adhesive. As was previously described, the nonporous, moisture-permeable film 10 may be a hydrophilic polymer film or a composite of a hydrophilic polymer and a support. In the case of using a nonporous, moisture-permeable film formed with a hydrophilic polymer and a support, the hydrophilic polymer is preferably positioned on the side of the cover 32. As a result of employing such an orientation, the nonporous, moisture-permeable film 10 can be affixed and adhered to the cover 32 by the hydrophilic polymer. In addition, an O-ring or other sealing member may be provided at the location where contact is made between the container body 30 and the cover 32 to improve the seal between the container body 30 and the cover 32. Moreover, the cover 32 may be fastened to the container body 30 using a separate mechanical fastener (such as a clamp) to prevent separation of the container body 30 and the cover 32 during freeze-drying.

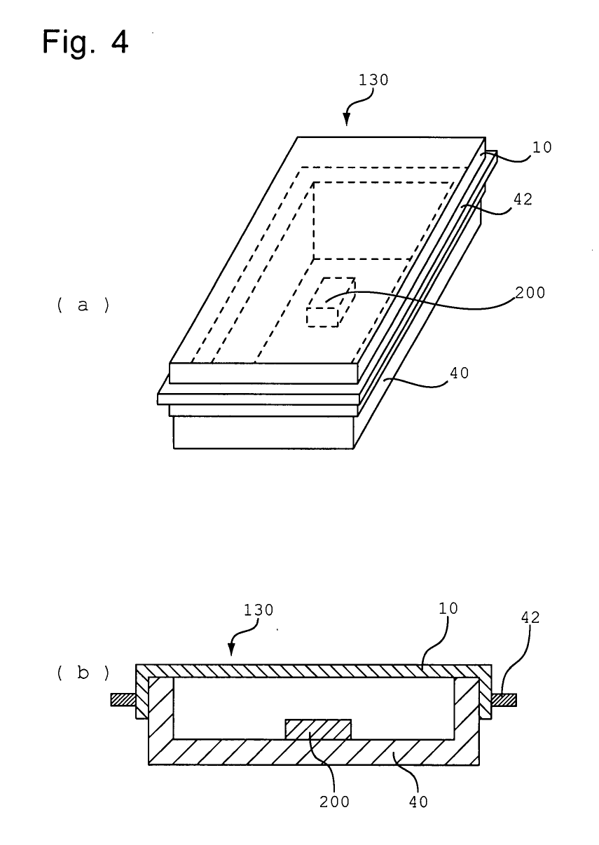

Still another aspect of the container for freeze-drying of the present invention is shown in FIG. 4. FIG. 4A is a perspective view of a container for freeze-drying 130, while FIG. 4B is a cross-sectional elevation of the same. The container for freeze-drying 130 is composed of a container body 40 for housing an article to be freeze-dried 200, a nonporous, moisture-permeable film 10 that covers an opening of the container body 40, and a tightening member 42 that presses the nonporous, moisture-permeable film 10 against the container body 40. The container body 40 is formed using a material impermeable to moisture and contaminants known in the art (such as metal or plastic). As was previously described, the nonporous, moisture-permeable film 10 may be a hydrophilic polymer film or a composite of a hydrophilic polymer and a support. In the case of using a nonporous, moisture-permeable film formed with a composite of a hydrophilic polymer and a support, the hydrophilic polymer is preferably positioned on the side of the container. As a result of employing such an orientation, the effect of the support of improving mechanical strength can be demonstrated effectively. Any arbitrary member able to adhere the nonporous, moisture-permeable film 10 to the container body 40 in a state that does not allow the passage of contaminants can be used for the tightening member 42.

In each of the above-mentioned aspects of the container for freeze-drying, a valve (not shown) may be provided for preventing the container from rupturing due to the sudden release of moisture from the article to be freeze-dried. A pressure relief valve that opens when the difference between the pressure within the container for freeze-drying and the external pressure has reached or exceeded a threshold value, and closes when that pressure difference has fallen below that threshold value can be used for such a valve. Here, since gas flows from the inside to the outside of the container for freeze-drying when the pressure relief valve is open, contaminants are prevented from flowing into the container for freeze-drying (namely, contamination is prevented). Alternatively, a valve may also be used that allows the open and closed states to be switched by an operation performed from the outside. Regardless of which type of valve is used, the opening of the valve is preferably as small as possible.

Freeze-drying using the container for freeze-drying of the present invention can be carried out using an arbitrary freeze-drying apparatus known in the art. A typical freeze-drying apparatus that uses a vacuum comprises, for example, a drying chamber equipped with a shelve for holding a container for freeze-drying containing an article to be freeze-dried and adjusting the temperature of the article to be freeze-dried, a heating and cooling unit for regulating the shelf to a suitable temperature, a capturing unit (such as a cold trap) for capturing moisture released from the article to be freeze-dried, and a vacuum unit (such as a vacuum pump) for reducing pressure inside the apparatus.

First, after placing a container for freeze-drying containing an article to be freeze-dried on the shelf in the drying chamber, the shelf is cooled using the heating and cooling unit to preliminarily freeze the article to be freeze-dried. Alternatively, the article to be freeze-dried that has been pre-frozen using a separate unit may be arranged on the shelf in the drying chamber. In the case the article to be freeze-dried is a eutectic mixture, it is necessary to cool the article to a temperature equal to or lower than the eutectic point thereof. Ordinarily, the article to be freeze-dried is cooled to about −40° C. Air, nitrogen or an inert gas (such as argon) can be used for the gas inside the drying chamber.

Next, the pressure inside the freeze-drying apparatus is reduced to sublimation dry the article to be freeze-dried. The pressure inside the freeze-drying apparatus is reduced to about 107 Pa (about 0.8 mmHg) or less and preferably to about 1 to 107 Pa (about 0.008 to 0.8 mmHg) to sublimate ice to water vapor without going through a liquid state. Here, in the case of using a pouch-like container for freeze-drying as shown in FIG. 1, the container for freeze-drying may be arranged in a rigid member (such as a steel box) having a multiplicity of openings therein, and expansion of the container for freeze-drying may be suppressed to within a certain limit by that member to prevent the container for freeze-drying from rupturing. During the sublimation drying step, the shelf within the drying chamber is maintained at an adequate temperature for supplying a latent heat of sublimation using the heating and cooling unit. The suitable temperature of the shelf is determined dependent upon the type of article to be freeze-dried. For example, in the case the article to be freeze-dried is a eutectic mixture, the temperature of the article to be freeze-dried is required to be maintained at a temperature equal to or lower than the eutectic point thereof in this step as well.

Water vapor released from the article to be freeze-dried by sublimation is captured by a cold trap or other type of capturing unit. In the case of using a cold trap, the cold trap is cooled to a temperature below the temperature of the article to be freeze-dried, and preferably to a temperature that demonstrates a water vapor pressure sufficiently lower than the water vapor pressure of water at the temperature of the article to be freeze-dried (for example, −50 to −60° C.).

The sublimation drying process may also be carried out in two steps. In the first step, the majority of the moisture in the article to be freeze-dried (moisture other than bound water) is removed, and this is carried out at a comparatively low temperature and a comparatively high pressure. In the second step, bound water bound to the components in the article to be freeze-dried is removed, and this is carried out at a comparative high temperature and a comparatively low pressure. The temperature and pressure used in each step are determined dependent upon the article to be freeze-dried. For example, the temperature and pressure in the first step are selected so that the resistance to air flow of a dry portion of the article to be freeze-dried does not cause a local rise in pressure (and resulting melting of water). In particular, the temperature is set to be lower than the collapse temperature of the article to be freeze-dried. On the other hand, in the second step, the temperature is selected so as not to cause deterioration of the article to be freeze-dried, and the pressure is selected so as to maintain the article to be freeze-dried in a frozen state at the temperature used.

Although selected arbitrarily, an air flow generation unit (such as a fan) may be used to generate air flow from the container for freeze-drying containing the article to be freeze-dried towards the cold trap to promote freeze-drying. Moreover, gas from which moisture has been captured and removed in the cold trap may be reheated and circulated to the drying chamber housing the article to be freeze-dried.

Alternatively, freeze-drying can also be carried out at atmospheric pressure by allowing a drying gas to flow into a circulating air path provided with a condenser and an evaporator (see Japanese Patent Application Laid-open No. 2006-118835).

### EXAMPLE

Preparation of Article to be Freeze-Dried

10.05 g of sugar were dissolved in 100 mL of water to prepare an aqueous sugar solution for use as an article to be freeze-dried.

Preparation of Container for Freeze-Drying

A nonporous, moisture-permeable film was formed by extrusion laminating a copolyether ester elastomer (Hytrel®, E. I. du Pont, having a heat sealing temperature of 200° C.) onto a polyester non-woven fabric. The resulting copolyether ester elastomer layer had a film thickness of 20 μm, and the nonporous, moisture-permeable film had a total film thickness of 160 μm. The composite was cut to a size of 18 cm×50 cm and folded in half with the copolyether ester elastomer layer on the inside. The nonporous, moisture-permeable films were sealed on two sides of the folded composite using a 200° C. heat sealer while one side was left open to form a pouch-like container for freeze-drying (dimensions: 18 cm×25 cm).

### Example 1

The metal Petri dish and the above-mentioned container for freeze-drying used were weighed. Next, approximately 20 g of aqueous sugar solution (article to be freeze-dried) were weighed out into the metal Petri dish. Next, the metal Petri dish was placed in the container for freeze-drying followed immediately by heat sealing the nonporous, moisture-permeable films on the open end of the container for freeze-drying using a 200° C. heat sealer to seal the container for freeze-drying. The sealed container for freeze-drying was cooled to about −20° C. over the course of about 15 hours to pre-freeze the article to be freeze-dried in the form of the aqueous sugar solution for use as a sample.

Next, the sample was weighed and placed on a shelf of the drying chamber of a vacuum freeze-drying apparatus. Continuing, the pressure inside the freeze-drying apparatus was reduced to a pressure of 30 Pa followed by freeze-drying over the course of 24 hours under conditions maintained at an environmental temperature (temperature inside the drying chamber) of −40° C. and temperature of the shelf inside the drying chamber of 40° C.

After freeze-drying for 24 hours, the sample was weighed and the residual moisture content was calculated from weight difference of the sample before and after freeze-drying and the weight of the aqueous sugar solution (article to be freeze-dried) used. The residual moisture content in this example was determined to be 2.2%. The results are shown in Table 1.

### Example 2

Freeze-drying was carried out by repeating the procedure of Example 1 with the exception of using water instead of aqueous sugar solution for the article to be freeze-dried, and weighing the article to be freeze-dried directly in the container for freeze-drying without using a metal Petri dish. The residual moisture content was 0.0%. The results are shown in Table 1. On the basis of these results, the container for freeze-drying of this example was determined to be useful as a container for freeze-drying by having the functions of releasing moisture from the article to be freeze-dried and preventing contamination from the outside.

### Comparative Example 1

Freeze-drying was carried out by repeating the procedure of Example 1 with the exception of not using a container for freeze-drying. The residual moisture content was 1.3%. The results are shown in Table 1.

### Comparative Example 2

Freeze-drying was carried out by repeating the procedure of Comparative Example 1 with the exception of using water instead of aqueous sugar solution. In this comparative example, since the weight of the sample after freeze-drying was less than the weight of the sample before freeze-drying, the residual moisture content was calculated to be −0.1%. The results are shown in Table 1. The increase in weight after freeze-drying is believed to be the result of measurement error.

TABLE 1
Evaluation Results

| | | | Comp. | | Comp. |
|---|---|---|---|---|---|
| | | Example 1 | Ex. 1 | Example 2 | Ex. 2 |
| Article to be freeze-dried | | Aqueous | Aqueous | Water | Water |
| | | sugar | sugar | only | only |
| | | solution | solution | | |
| Metal Petri dish | | Used | Used | Not used | used |
| Container for | | Used | Not used | Used | Not used |
| freeze-drying | | | | | |
| Weight | Sample | 20.30 | 19.18 | 18.06 | 19.74 |
| before | total (g) | | | | |
| freeze-drying | Sugar (g) | 1.94 | 1.83 | 0.00 | 0.00 |
| | Moisture | 18.36 | 17.35 | 18.06 | 19.74 |
| | (g) | | | | |
| Sample weight after | | 2.35 | 2.05 | 0 | −0.01 |
| freeze-drying | | | | | |
| Residual | Weight (g) | 0.41 | 0.22 | 0.00 | 0.00 |
| moisture | Residual | 2.2 | 1.3 | 0.0 | −0.1 |
| | moisture | | | | |
| | content | | | | |

### Example 3

A sample was obtained by carrying out the same procedure as Example 1.

Next, the sample was weighed and placed on the shelf of a vacuum freeze-drying apparatus. At this time, a metal Petri dish containing an aqueous acetic acid solution was placed on the shelf in the drying chamber. Continuing, the pressure inside the freeze-drying apparatus was reduced to a pressure of 30 Pa, and freeze-drying was carried out over the course of 24 hours under conditions maintained at an environmental temperature (temperature inside the drying chamber) of 40° C. and a temperature of the shelf inside the drying chamber of 40° C.

After freeze-drying for 24 hours, the aqueous acetic acid solution inside the metal Petri dish had disappeared and the smell of acetic acid was present in the drying chamber. As a result of weighing the sample after freeze-drying, the residual moisture content of this example was determined to be 0.0%. Continuing, when the container for freeze-drying was opened, there was no smell of acetic acid either within the container or in the freeze-dried article. On the basis of these results, the container for freeze-drying was clearly demonstrated to have the ability to block out gaseous acetic acid present in the surrounding environment during freeze-drying as well as prevent contamination of the freeze-dried article by acetic acid.

On the basis of the results obtained from the examples and comparative examples as previously described, the use of the freeze-drying container of the present invention was clearly determined to be able to be adequately applied to freeze-drying while preventing contamination.

What is claimed is:

1. A container adapted for sealing and housing a freeze-dried article therein, wherein at least a part of the container is made of a nonporous moisture-permeable film.

2. The container according to claim 1, wherein the nonporous moisture-permeable film comprises a hydrophilic polymer selected from the group consisting of copolyether urethane, a mixture of two or more types of copolyether urethanes, copolyether ester elastomer, a mixture of two or more types of copolyether ester elastomers, polyether block polyamide, a mixture of two or more types of polyether block polyamides, a homopolymer or copolymer of polyvinyl alcohol, and two or more types of homopolymers or copolymers of polyvinyl alcohol.

3. The container according to claim 2, wherein the nonporous moisture-permeable film is a composite of the hydrophilic polymer and a support.

4. The container according to claim 1, wherein the entire container is formed from the nonporous moisture-permeable film.

5. The container according to claim 1, comprising a tray in which an article to be freeze-dried is placed, and the nonporous moisture-permeable film affixed to an opening of the tray.

6. The container according to claim 1, comprising a container body adapted for having an article to be freeze-dried placed therein, and a cover removably attached to the container body and having the nonporous moisture-permeable film arranged on at least a portion of the cover.

7. The container according to claim 1, comprising a container body adapted for having an article to be freeze-dried placed therein, the nonporous moisture-permeable film covering an opening of the container body, and a tightening member that presses the nonporous moisture-permeable film against the container body.
